(19) United States
(12) Patent Application Publication
(10) Pub. No.: US 2020/0160447 A1
(43) Pub. Date: May 21, 2020

(54) MOTIF SEARCH AND PREDICTION IN TEMPORAL TRADING SYSTEMS

(71) Applicant: Trendalyze Inc., Newark, NJ (US)

(72) Inventors: Radoslav P. Kotorov, Somerset,, NJ (US); Dave Watson, Essex (GB)

(73) Assignee: Trendalyze Inc., Newark, NJ (US)

(21) Appl. No.: 16/681,655

(22) Filed: Nov. 12, 2019

Related U.S. Application Data
(60) Provisional application No. 62/768,954, filed on Nov. 18, 2018.

(51) Int. Cl. G06Q 40/04; G06Q 40/06; G06K 9/62; G06N 5/04; G06Q 30/02

(52) U.S. Cl. CPC G06Q 40/04; G06Q 40/06; G06Q 30/0201; G06N 5/046; G06K 9/6215

(57) ABSTRACT

A method and system for discovering motifs in time series data from trading activities and using them to predict future trading trends. Each motif contains a set of sequential data points and its shape uniquely describes the trading events for a specified time period. Selected motifs are used as search references to find similar or dissimilar motifs within all or any sub-segment of the time series data and a similarity score is calculated for all matches. An artificial intelligence network learns the relationship between the similarity scores of the motifs and the subsequent trading events. The artificial intelligence network evaluates the shape of any trading motif, compares it with the learned motifs, and generates a prediction for the most likely motif to occur in the next trading period.

### CROSS-REFERENCE TO RELATED APPLICATION

This application claims priority and benefit under 35 U.S.C. 119(e) of U.S. Provisional Patent Application No. 62/768,954, titled “Motif Search and Prediction in Temporal Trading Systems” and filed on Nov. 18, 2018, which is hereby incorporated by reference to the maximum extent permitted by applicable by law.

### FIELD OF THE INVENTION

The present invention relates to the field of data analysis and prediction methods and systems, and more specifically to artificial logical networks.

### BACKGROUND OF THE INVENTION

A trading system is a many-to-many network of buyers and sellers to conduct business in real or near real time. Trading systems exist for stocks, commodities, crypto currency, other securities, and many other non-financial goods. The trading systems record large volumes of transactions and give their users access to detailed pricing fluctuations and trends to make informed decisions.

All recorded trading activities are typically summarized and shown on time series charts which give traders clear picture of how the trading occurs over time. The time series charts are extremely valuable because they reveal the direction of the trading activities, i.e., the market trending up or down, prices going up or down, etc. The participants in any temporal trading activities can benefit enormously if they can predict correctly the direction of the market in some future period. Hence, a lot of analytical systems, methods and algorithms have been developed to predict market sentiment and price trends. Such predictions are referred to as market signals.

Trading trend predictions (signals) can be developed using many different technologies such as Microsoft Excel, MATLAB®, TradeStation, R, Python, and other platforms and languages. The buy and sell signals from these platforms may appear in a file that is passed either programmatically or manually to be executed on the actual trading platform. There are many of different inputs that can be used when building trading signals systems. The present invention differs from the prior art because it leverages the shapes (called motifs) within the time series trading data, performs shape (motif) comparisons, and generates predictions based on the consensus of the motifs involved in the comparisons.

The proliferation of sensors and monitoring devices has caused an explosion of granular data collection from various events and processes. This data, often collected on minutes, seconds, milliseconds, and nanoseconds, has identical properties to the trading data. Hence, the present method can be applied in all granular sequential data to generate predictive signals. For example, it can be applied within remote cardio monitoring devices to alert physicians when a pathology occurs or to predict when a pathology is likely to occur. It also can be applied for industrial equipment monitoring where vibration censors generate nanosecond level data samples.

The present invention can be applied in various searching systems present in the market and also, eliminates the drawbacks in the prior art by providing methods and systems that leverages the shapes (called motifs) within the time series trading data, performs shape (motif) comparisons, and generates predictions based on the consensus of the motifs involved in the comparisons.

### SUMMARY OF THE INVENTION

This summary is not an extensive overview, and it is not intended to identify key/critical elements or delineate the scope thereof. Its sole purpose is to present some concepts in a simplified form as a prelude to more detailed description that is presented late.

The present invention is a method and system provided to configure and deploy an artificial logical network for detection, classification, or prediction of sequential data motifs, trends or patterns. The method includes a batch or real time ingestion of time series or sequential data, i.e., data in which each consecutive measurement is identified either by a unique sequence number or by a unique time stamp, means to select and store motifs into a library, means to configure motifs into an artificial logical network capable of self-learning, and means to deploy the said artificial logical network against any data sources to generate predictions.

According to the present method, motifs can be discovered and selected either through automated machine profiling or through interactive visual exploration of time series or line charts. A motif comprises of a subset of data points selected from an entire time series. For example, a complete day of bitcoin trading can be represented on a minute by minute basis by a time series with 1440 data points. A 30 minutes/points selection within this time series is a motif. Motifs can have any length. The method further provides means to configure all or a subset of the motifs stored in the library in an artificial logical network to evaluate new data and generate predictions. Each reference motif in the artificial logical network represents a particular outcome. A trading trend motif can represent an upward or downward market movement. Cardio motifs may represent different types of heart pathologies. Industrial equipment motifs can represent different types of failures. The artificial logical network generates predictions by passing new data through the network nodes and by evaluating the similarity of the incoming motif to each reference motif. Each node contains a reference motif, computes a similarity score and applies logical rules to determine the weight of the node in the prediction process. The node's final score is used as “voting” token in the artificial logical network. The closer the matching score between the incoming data and a reference motif the higher the weight of the reference motif in predicting the outcome. The method generates a final prediction by tallying the “votes”. For example, if an artificial logical network contains 50 nodes and 10 of them vote that the market will go up while the other 40 nodes vote that the market will go down, the nodes consensus predict that the market will go down. Nodes can be organized into layers. The method further provides self-learning and adaptation of the artificial logical networks. As new motifs emerge in the incoming data, the method evaluates their similarity to the current reference motifs. If the new motifs are substantially different, they are added as new nodes. Similarly, nodes that that show consistently low voting power can be automatically removed from the network. The dynamic learning maintains or increases the accuracy of the predictions over time.

In one embodiment, a computer based system for configuring and deploying artificial logical networks for time series and sequential data is provided. The computer based system includes a data store configured for ingestion and querying of disparate time-series and sequential data sets with diverse layout formats without conforming to a schema, a data services interface module configured to provide data connections to external data sources for data ingestion into the said data store, a server configured to process motif selections and configuration of artificial logical networks against the said data store, and to pass results from the said artificial logical networks for display and analysis on user computer devices, the server further being configured to embed results in applications and monitoring devices, and a graphical user interface accessible on user computer devices for interactive visualization, exploration or configuration of artificial logical networks.

In another embodiment, a computer program product embodied in non-transitory computer-readable media carrying executable code is provided, wherein the code, when executed, produces a query against a time-series or sequential data set to retrieve a time sequence, where the said time sequence is passed through a plurality of nodes within an artificial logical network where each node evaluates the said time sequence against a reference time sequence to compute a similarity score and apply logical rules to the said similarity score to determine the weight of each node in generating census based predictions about some desired outcome. The code, when executed, further provides continuous ingestion and continuous generation of predictions on real time data streams where the said predictions are passes to other systems or are used to generate and deliver real time alerts.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 shows a display of time-series data on a computer device chart, according to an embodiment of the present invention.

FIG. 2A shows sequentially related time-series motifs, according to an embodiment of the present invention.

FIG. 2B shows reference motifs selected for sequential predictions, according to an embodiment of the present invention.

FIG. 3 shows multidimensional correlated time-series sequences, according to an embodiment of the present invention.

FIG. 4A shows an artificial logical network configuration for a single input and a single prediction, according to an embodiment of the present invention.

FIG. 4B shows an artificial logical network configuration for a single input and multiple predictions, according to an embodiment of the present invention.

FIG. 5A shows an artificial logical network configuration with multiple layers and inputs, according to an embodiment of the present invention.

FIG. 5B shows an artificial logical network with multiple layers and aggregators, according to an embodiment of the present invention.

FIG. 6 shows an artificial logical network with nested nodes, according to an embodiment of the present invention.

FIG. 7 shows the similarity score generation within nodes, according to an embodiment of the present invention.

FIG. 8A shows the application of logical rules with nodes, according to an embodiment of the present invention.

FIG. 8B shows scores aggregation across all nodes, according to an embodiment of the present invention.

FIG. 8C shows scores weighting within nodes, according to an embodiment of the present invention.

FIG. 9 shows a high-level overview of the system for artificial logical networks, according to an embodiment of the present invention.

FIG. 10 shows a high-level overview of an artificial logical network deployed in an external application, according to an embodiment of the present invention.

### DETAILED DESCRIPTION OF THE INVENTION

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing program code. The storage devices may be tangible, non-transitory, and/or non-transmission.

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto. Additionally, any examples set forth in this specification are not intended to be limiting and merely set forth some of the many possible embodiments for the claimed invention. Among other things, the present invention may be embodied as methods or devices. Accordingly, the present invention may take the form of an entirely hardware embodiment, and entirely software embodiment, or an embodiment combining software and hardware aspects. The following detailed description is, therefore, not to be taken in a limiting sense.

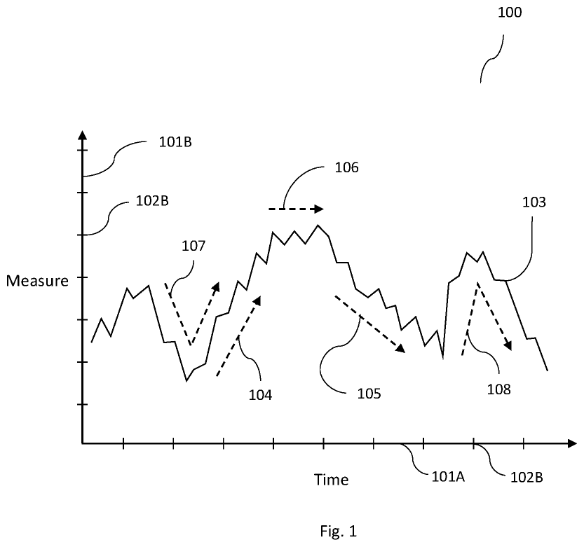

FIG. 1 shows a display of time-series data on a computer device line chart 100. 101 is the “Y” axis for the values of each measurement. 102 is the “X” axis displaying the time stamp or the sequence number for each measurement. Those skillful in the are would know that measurements can be aggregated at different levels of time granularity. 103 is the time series. 104 is an illustrative line showing an upward trend within a sub segment of the time series 103. 105 is an illustrative line showing a downward trend within another sub segment of the time series 103. 106 is an illustrative line showing a stable horizontal trend within a sub segment of the time series 103. 107 is an illustrative line showing a “V” shaped trend (downward-to-upward) within a sub segment of the time series 103. 108 is an illustrative line showing an inverted “V” shaped trend (upward-to-downward) within a sub segment of the time series 103. Depending on the nature of the measured process the trend shapes can have many different shapes and curvatures.

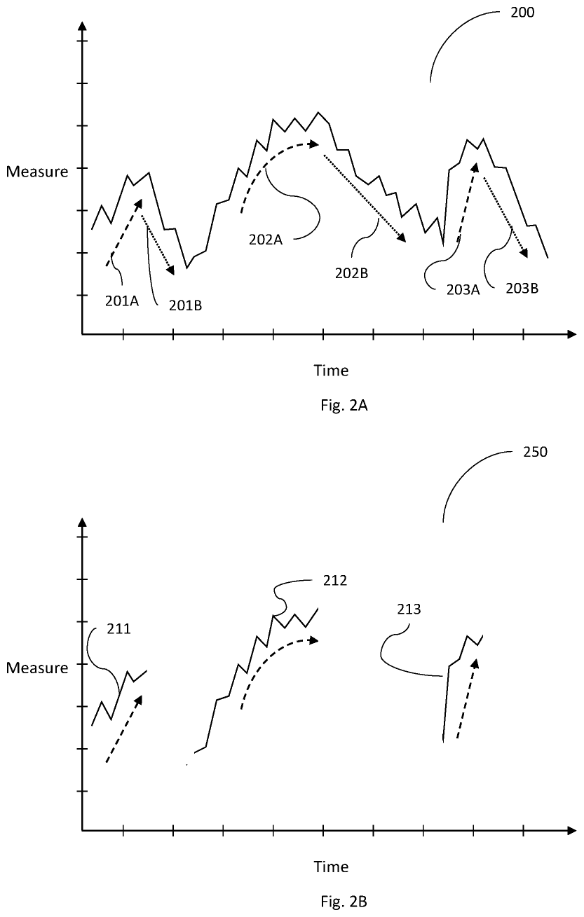

FIG. 2A shows sequentially related time-series motifs on a line chart 200. 201A shows an upward trend followed immediately by a downward trend 201B. 202A shows a curved upward trend followed immediately by a prolonged downward trend 202B. 203A shows another sharp upward trend followed by a steep downward trend 203B. Motifs from sequentially related trends can be used to predict the occurrences of the related motifs. There is no limit to the number of sequentially related motifs in a single trend.

FIG. 2B shows just the reference motifs 201A, 202A and 203A selected and referred as 211, 212 and 213 respectively for sequential predictions 250. Each one of these motifs can be used to predict a downward trend. The three motifs can be configured in a logical network to collectively predict a downward trend. Predictions based on a set of motifs increase the accuracy as the shapes of the trends tend to vary.

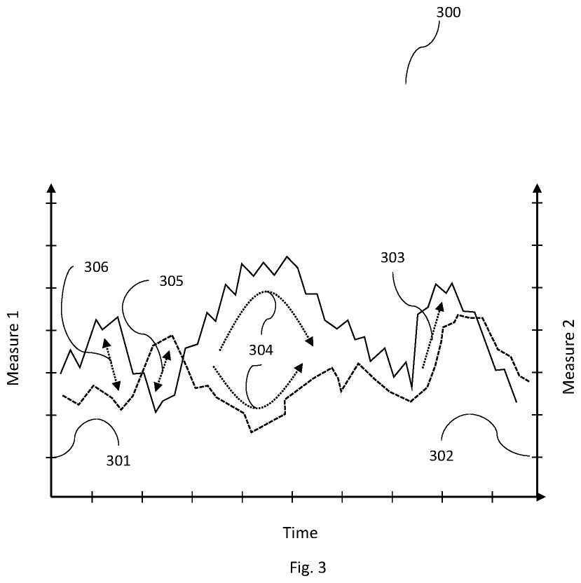

FIG. 3 shows multidimensional correlated time-series sequences 300 where measurements are taken from one or more measures. 301 is the “Y” axis for Measure 1 and 302 is a secondary “Y” axis for Measure 2. 303 and 304 are the two time-series—the two different dimensions for which measurements are recorded over time. 305 shows a pattern where the measurements go in opposite directions. 306 shows a pattern where the measurements go in the same direction. 307 shows a complex curved pattern where the two motifs have opposite directions. For those skillful in the art it will be obvious that the multidimensional motifs can have complex shapes. The trends from each dimension can occur simultaneously or be offset in time. A multidimensional motif can be construed from any number of time series and segments within time series.

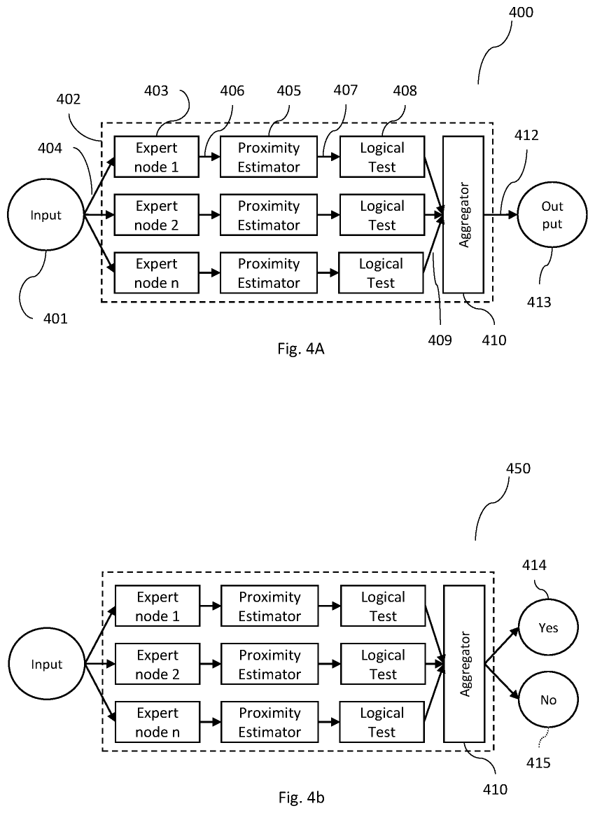

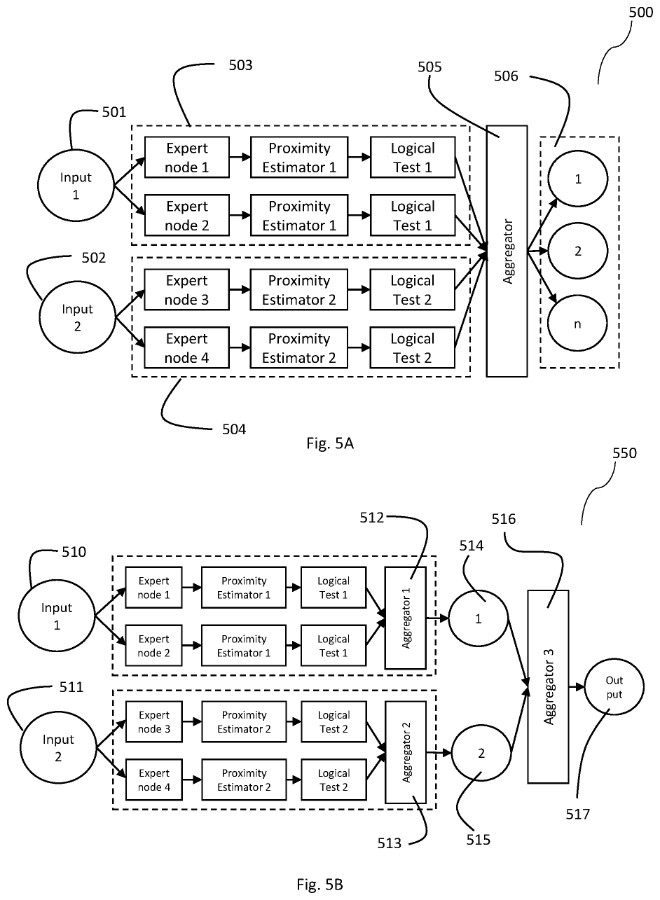

FIG. 4A shows an artificial logical network configuration 400 for a single input 401 and a single prediction output 409. 401 is an external input, i.e., an incoming time-series sequence of a particular length. Each input is a motif to be evaluated by the artificial logical network. Each input 401 is passed via method 402 to each expert node 403 configured in the network. Each node has a proximity estimator 405 that computes a similarity score between the reference motif within the node 403 and the input 401. Various algorithms for similarity computations can be configured for each proximity estimator 405. The generated score by the proximity generator 405 is evaluated by the logical test component 406. In one embodiment of the present invention the logical test can be a simple comparative condition such as “greater than”, “less than” of “equal to”. Those skillful in the art will know that various logical tests can be configured. The results of the logical tests 406 from all nodes 403 are passed to the aggregator 407 to generate a consensus-based prediction output 409.

FIG. 4B shows an artificial logical network configuration 450 for a single input and multiple predictions 414 and 415. The example illustrates a binary prediction such as “Yes/No” or “0/1”, but it can be a classification too such as “Black/White”, or any other. The artificial logical network can generate any number of predictions.

FIG. 5A shows an artificial logical network configuration 500 with multiple inputs and multiple layers. 501 is Input 1 and 502 is Input 2. The inputs a split and passed through two separate layers 503 and 504 of the artificial logical network. For those skillful in the art, it will be obvious that multiple inputs can be passed through a single layer or multiple layers. This will depend on the nature of the business problem which the artificial logical network is configured to solve. Each layer 503 and 504 has its own nodes. The outcomes of each node within each layer are passed to the aggregator 505 to generate consensus-based predictions 506.

FIG. 5B shows an alternative configuration 550 of the artificial logical network from FIG. 5A where each layer 503 and 504 has its own aggregator 512 and 513. Aggregator 512 for layer 503 generates outcome 514. Aggregator 513 for layer 504 generates outcome 515. The results 514 and 515 are passed to a third aggregator 516 to generate the final prediction outcome 517. Such configuration is suitable for automated decision support where each layer is configured for a distinct process.

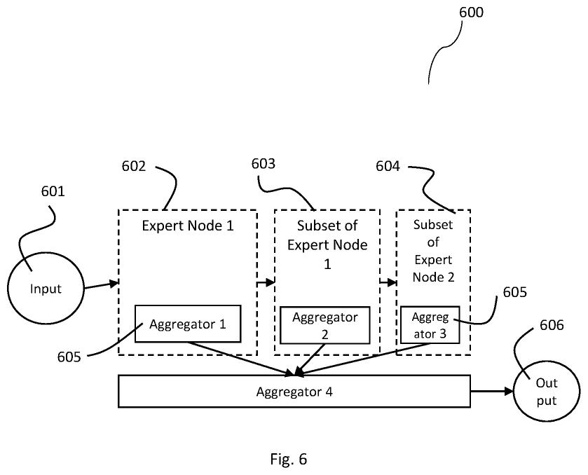

FIG. 6 shows an artificial logical network 600 with nested nodes. An input sequence 601 is passed to three expert nodes. Expert node 601 evaluates the entire length, i.e. all N points, of the input sequence and generates a prediction via aggregator 605. Node 603 evaluates a subset of the input sequence 601, as for example, only the second half of the points in it. Node 603 evaluates even a smaller subsegment of the input sequence 601, as for example, the last ⅓ of the points in it. This configuration is particularly useful to increase the accuracy of predictions. For example, input signals of 60 minutes, 30 minutes and 15 minutes can be evaluated to determine the direction of market in assets trading. Any number of subsequences can be configured. The evaluations of every node are passed to the aggregator 606 to generate the final prediction 607.

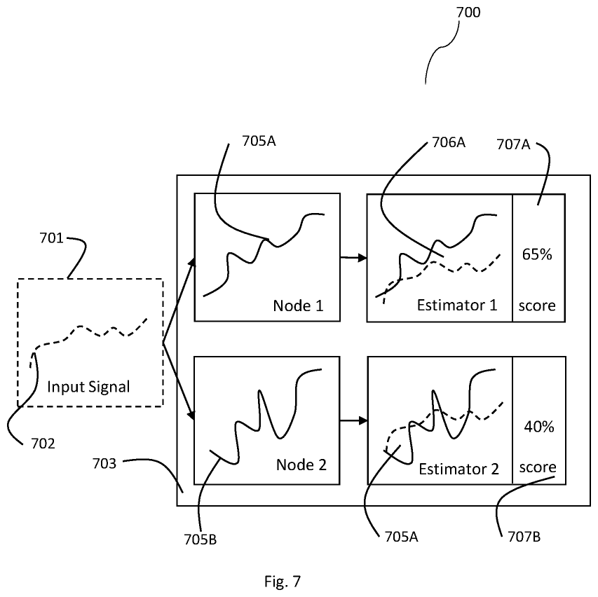

FIG. 7 shows the similarity score generation 700 within nodes. 701 is an input signal coming from a device, sensor or system. The input signal 701 come into the system as a numeric array but for explanatory purposes we show the graphical shape of motif 702. The motif 702 is passed to Node 1 and Node 2. 703A is the graphical shape of the reference motif in Node 1 and 703B is the graphical shape of the reference motif in Node 2. The two reference motifs are also stored as numerical arrays. As it can be seen reference motifs 703A and 703B have different shapes. 704A shows for illustration purposes the overlay of the reference motif 703A and the input motif 702. 704B shows for illustration purposes the overlay of the reference motif 703B and the input motif 702. The visual illustration shows the difference in shapes between the reference motifs 703A and 703B and the input motif 702. The estimators compute the differences between the motifs based on the mathematical properties of the corresponding numeric arrays. For those skillful in the art it will be obvious that there are many mathematical algorithms to compute the differences between arrays such as Euclidean, Manhattan, Pearson, etc. Each node estimator generates a similarity score. 705A is the similarity score for Node 1 and 705B is the similarity score for Node 2. The similarity scores can be expressed as numbers or percentages. Similarity scores generated by different algorithms can have different scales but can be normalized or expressed as percent difference.

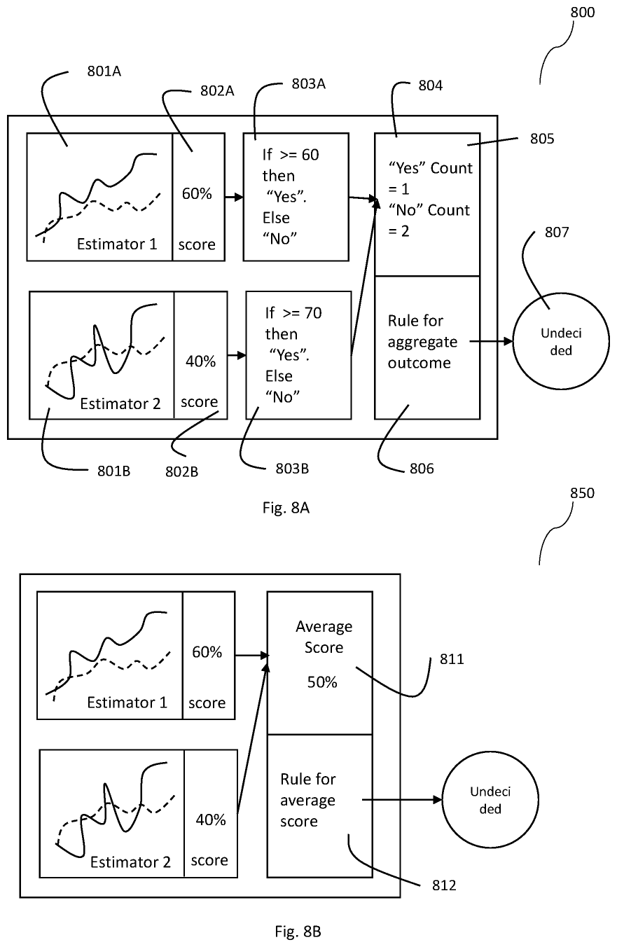

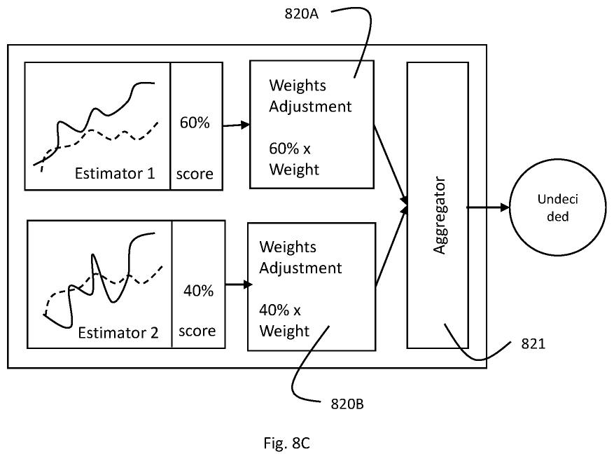

FIG. 8A shows the application of logical rules 800 within nodes. 801A and 801B are the scores generated within two nodes as described in FIG. 7. 802A is a logical test for a threshold, i.e., if the SOCRE is grater or equal to VALUE, then X, else Y. In 802A the threshold is set to 60%, and the results of the test are “Yes” or “No”. Node 2 has a logical test 802B with a higher threshold set to 70%. Those skillful in the art will know that logical tests can be configured in many ways and may include many ELSE conditions, also referred as CASES logic. The results of each logical test are passed to the aggregator 803. The aggregator 803 has a counter 804 that tallies the logical test results. The results of the counter 804 are processed by a rule applicator 805 that generates the final prediction 806. In this example the rule applicator can be as a simple majoritarian rule. If the “Yes” outcomes are more than 50%, then the final prediction is “Yes”. A variety of rules can be configured for the rule applicator.

FIG. 8B shows a different aggregator 850 based on a mathematical equation. In this example it is the average computation 811 of all scores from all nodes. For those skilled in the art it will be obvious that many equations can be configured in the aggregator 810. 812 is the rule applicator that generates the final prediction from the artificial logical network.

FIG. 8C shows two weight applicators 820A and 829B configured for each node in the artificial logical network. The weight applicators adjust the relative importance of the scores generated by each node in predicting the final outcome. Weight applicator 820A adjusted the score of Estimator 1 to 67% while weight applicator 820B adjusted the score of Estimator 2 to 33%. After the adjustment Node 1 has twice as much weight in deciding the outcome than Node 2. Weights can be assigned by domain experts or computed from data.

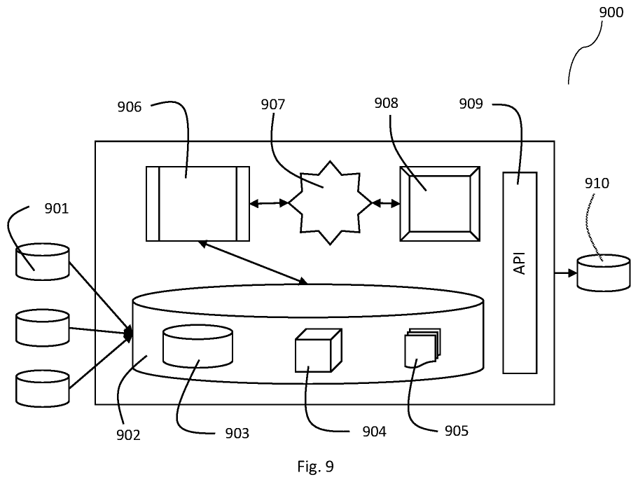

FIG. 9 shows a high-level overview of the system 900 for artificial logical networks. 901 are external data sources from which data is ingested into the system 900. 902 is a server that ingests and stores data 903, processes and stores artificial logical networks 904 based on the stored data 903, processes and saves motifs in the motif library 905 to be used in artificial logical networks. 906 is a logical metadata layer that mediates all interactions between the server 902, the front-end user interface 908, and the query generator 907 that creates execution commands based on user inputs. The system further comprises of API which allows users to configure and run artificial logical networks programmatically. 910 is an external system to which the outputs of the artificial logical network are passed. The API 910 is also used to deploy the artificial logical network in an external application, i.e., an embedded artificial logical network in a third-party application.

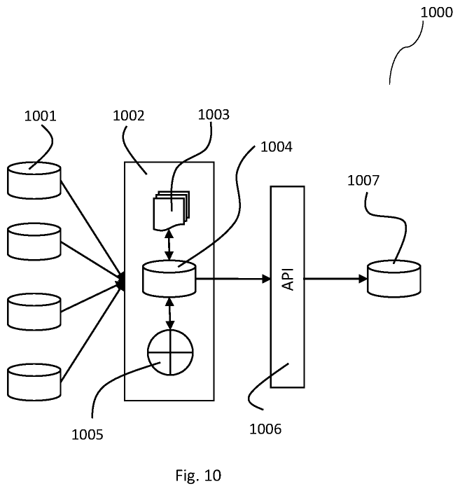

FIG. 10 shows a high-level overview of an artificial logical network 1000 deployed in an external application. 1001 are external data sources. 1002 is a server that ingests data from the external data sources 1001 and stores data 1004. The system further comprises of API 1006 which allows users to configure and run artificial logical networks programmatically.

In one embodiment, the method and system provides a GUI accessible on user computer devices for interactive visualization and exploration of sequential data in artificial logical network and the user can explore how different algorithms affect the distance scores, and determine which one is good to use for the generation of distance scores.

In another embodiment, the method and system provides interactive controls via graphical user interface for user to input a query for obtaining network prediction outcomes generated by aggregating distance scores that are generated by comparing a sequential data input with reference sequences in computational network nodes.

While the invention has been described in detail with specific reference to preferred embodiments thereof, it is understood that variations and modifications thereof may be made without departing from the true spirit and scope of the invention.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific invention embodiments have been described, these are not intended to be limiting. Various modifications and equivalents are within the scope of the following claims. The modifications include any relevant combination of the disclosed features.

I/We claim:

1. A method using an artificial logical network for predicting patterns and events in sequentially ordered data, the method comprising:
a. selecting a plurality of reference sequences from the sequentially ordered data;
b. configuring the selected plurality of reference sequences into a plurality of network nodes;
c. configuring one or more vector comparisons for the plurality of network nodes for generating one or more distance scores between the plurality of reference sequences and an input signal sequence;
d. configuring a logical test for evaluating the one or more distance scores to generate one or more prediction outcomes for the plurality of network nodes;
e. configuring a consensus aggregator to generate a prediction outcome for the artificial logical network from the one or more prediction outcomes of the plurality of network nodes;
f. distributed processing of the input signal sequence through the plurality of network nodes.

2. The method of claim 1, wherein the sequentially ordered data is a time series data.

3. The method of claim 1, wherein the plurality of references sequences are visualized and selected from an interactive line chart and saved in a digital data store.

4. The method of claim 1, wherein the artificial logical network contains at least one node.

5. The method of claim 1, wherein the plurality of network nodes can be grouped into one or more network layers processing one or more input signal sequences.

6. The method of claim 5, wherein one or more aggregators can be configured for the one or more network layers.

7. The method of claim 1, wherein subsets of reference motifs can be configured in sequentially related nodes for segmented vector comparisons.

8. The method of claim 1, wherein the one or more distance scores are algorithmically generated.

9. The method of claim 8, wherein the algorithm for generating the one or more distance scores can be varied by a user or by an application.

10. The method of claim 8, wherein plurality of algorithms can be applied across the plurality of network nodes.

11. The method of claim 1, wherein the logical test is algorithmically generated.

12. The method of claim 11, wherein the algorithm for the logical test can be varied by a user or by an application.

13. The method of claim 1, wherein the consensus aggregator prediction outcome is algorithmically generated.

14. The method of claim 13, wherein the algorithm for generating the prediction outcome by the consensus aggregator can be varied by a user or by an application.

15. The method of claim 1, wherein the one or more distance scores can be weighted by a user or an algorithm.

16. The method of claim 1, wherein the plurality of reference sequences are automatically excluded from the artificial logical network based on algorithmic learning of their relative contribution to the generation of past prediction outcomes.

17. The method of claim 1, wherein the plurality of reference sequences are automatically included in the artificial logical network based on algorithmic learning of their uniqueness relative to the existing reference sequences.

18. The method of claim 1, wherein the artificial logical network prediction outcome is programmatically passed to an external system.

19. An artificial logical network computer based system, comprising:
a. a data store configured for ingestion and processing of a plurality of disparate sequentially ordered data sets with one or more diverse layout formats without a schema;
wherein, the data store further configured to store one or more selected reference sequences from the plurality of disparate sequentially ordered data sets and to store one or more computational parameters for the one or more selected reference sequences;
b. a data services interface module configured to provide one or more data connections to one or more external data sources for data ingestion into the data store;
c. a server configured to process one or more queries for selection of reference sequences against the data store,
wherein, the server further configured to:
set one or more computational nodes for the reference sequences and to compute distances between the reference sequences and a plurality of sequences in the data store,
organize the one or more computational nodes into one or more networks for generating one or more prediction outcomes,
process one or more queries against a data set through the one or more computational nodes in the artificial logical network,
aggregate the one or more prediction outcomes of the one or more computational nodes into a prediction outcome from the artificial logical network,
embed the one or more prediction outcomes from the artificial logical network in applications and one or more monitoring devices; and
d. a graphical user interface accessible on one or more user computer devices for interactive visualization and exploration of sequential data,
wherein, the graphical user interface further configured for assembling the reference sequences into the one or more computational nodes and one or more networks.

20. The computer based system of claim 19, wherein one or more data streams from one or more internet connected devices are processed through the one or more computational nodes of the artificial logical network and a prediction outcome is being generated.

21. A computer program product embodied in non-transitory computer-readable media carrying executable code, the code when executed:
a. produces a query to generate one or more distance scores by comparing a sequential data input with one or more reference sequences configured in one or more computational network nodes;
b. generates one or more network prediction outcomes by aggregating the one or more distance scores.

22. The computer program product of claim 21, wherein the code when executed generates an interactive controls to navigate and explore the sequential data and configure the one or more computational network nodes.
